(19) United States
(12) Patent Application Publication
(10) Pub. No.: US 2007/0141544 A1
(43) Pub. Date: Jun. 21, 2007

(54) Apparatus for grading and evaluating compositional essays

(76) Inventor: Katsuaki Nakane, Kanagawa (JP)

Correspondence Address: RABIN & Berdo, PC, 1101 14TH STREET, NW, SUITE 500, WASHINGTON, DC, 20005, US

(21) Appl. No.: 10/580,545

(22) PCT Filed: Nov. 26, 2004
(86) PCT No.: PCT/JP04/17605

§ 371 Date: May 26, 2006

(30) Foreign Application Priority Data
Nov. 28, 2003 (JP) 2003-399577

(51) Int. Cl. G09B 7/00

(52) U.S. Cl. 434/353

(57) ABSTRACT

There is provided a device capable of evaluating a composition by a computer in the Internet. First, a task of a composition corresponding to the grade level of a learner and evaluation tasks are presented on the Internet. A compositional essay created by the learner according to the presented tasks and terms is evaluated by multiple methods associated with the evaluation tasks and the evaluation result is distributed to a grader responsible for evaluating the learner by means such as e-mail. The grader adds a comment to the evaluation result, records it in the server on the Internet, and displays the evaluation result in a graph or the like so that the learner can easily know the evaluation result. The apparatus for grading and evaluating compositional essays of the present invention is characterized in that (1) a compositional essay is divided into multiple fields such as structure, subject matter, expression, and topic and each of these fields is evaluated by the presence or lack of specified keywords and (2) the individuality of the content is evaluated by the amount and range of unique vocabulary contained in the compositional essay.

### FIELD OF THE INVENTION

The present invention relates to an apparatus used by a computer for grading and evaluating mainly essays and compositions by elementary through high school students.

### BACKGROUND ART

Conventional evaluation of essays and compositions is based on the subjective judgment of the grader. Even though it is subjective, as long as it is in line with criteria held in common by many people then the subjectivity in itself is not a problem. The problem is that if objectivity is required then the time and effort incurred by the evaluation of multiple graders becomes necessary.

Currently, the evaluation method being used in the U.S. is computerized grading. The majority of middle school report grading is already done by e-rater (a registered trademark)(hereinafter referred to as e-rater).

However, one problem with computerized grading is that if the accuracy of the evaluation is increased then a computer of corresponding computational capacity becomes necessary. Because of this, this evaluation method can currently still not be readily used on a personal computer level.

The second problem is that, due to the methodology that evaluates sentences |by the degree of separation from the various characteristics of the sentence groups set as standards, the evaluation of poorly written sentences is quite good but there is insufficient capability to evaluate well-written sentences.

The page shown below introduces the current condition of research in the U.S. concerning computerized sentence evaluation.

http://www.ets.org/research/dload/iaai03bursteinj.pdf

Non-patent document1: CriterionSM: Online essay evaluation: An application for the automated evaluation of student essays. August 2003.

This U.S. e-rater, in a form suitable for Japanese sentences, is being tested for the automated grading of essays in Japan as well.

Patent document1: Japanese Patent Application No. 2002-313004 “Sentence grading and evaluation apparatus, programs, and storage mediums”

A brief summary of this sentence grading and evaluation apparatus (hereinafter referred to as Jess (the program name)) can be viewed in the following document published and authored by the aforementioned applicant.

http://www.rd.dnc.ac.jp/˜tunenori/doc/jerater_ieice.pdf

Non-patent document2: System for the automated grading of Japanese essays by computer

The previous incarnation of this apparatus is a unique evaluation method developed by this school (Online composition school kotobanomori) during the initial phases of the compositional essay guidance initiation occurring in Japan in 1983. Accordingly, other automated grading efforts are similar in their awareness of the problem of using computers with the aim of lessening the burden placed on teachers by the evaluation of compositional essays but the methods, as described below, are very different.

### DISCLOSURE OF THE INVENTION

In the study of compositional essays, general Japanese abilities such as kanji comprehension, reading comprehension, and expressive power are necessary. These days, with the continuing decline of children's overall academic ability and the lowering of the age for entrance exam competition, many people are seeking to place emphasis back on the basic cultivation of reading and writing ability. However, while compositional essay tests to evaluate reading and writing ability are used in the college entrance exams of many college departments, it is difficult to say that there is sufficient use of these tests at the elementary, middle, and high school levels. The main reason for this is that the guiding goals that are the evaluation standards have not been established.

The present invention, along with greatly decreasing the time and effort involved in the evaluation of compositional essays, aims to widely spread the study of compositional essays through places of learning by clearly specifying the goals of writing and allowing children to experience the fun of writing.

The present invention solves the aforementioned problem through the Internet and computers.

This apparatus for grading and evaluating compositional essays of the present invention comprises a student learning the compositional essay, a student table wherein the class of the student and the appropriate teacher for the student is recorded, a task table wherein tasks suitable for the grade level are recorded, a term table wherein terms appropriate for the grade level and keywords capable of evaluating the inclusion of designated keywords that fulfill the requirements for a term are recorded, an evaluation table wherein evaluation results are recorded and accumulated, a first evaluation mechanism that evaluates the compositional essay input by the student in accordance with the previously designated aforementioned tasks based on the inclusion of the aforementioned keywords and the fulfillment of the aforementioned terms, a second evaluation mechanism that evaluates the compositional essay input by the student based on the amount of unique vocabulary used in constructing the sentence, a mechanism that sends via e-mail the evaluation results of the student's compositional essay the teacher designated in the student table, a mechanism that reflects in the evaluation table the constructive corrections that the teacher added to the evaluation results that were sent to the teacher, and a mechanism that clearly displays the evaluation results from the evaluation table in the form of a graph.

Also, in one example of the apparatus for grading and evaluating compositional essays of the present invention, the aforementioned first evaluation mechanism possesses a term table wherein keywords used to evaluate fields such as structure, subject matter, expression, topic, and the like that are common to essays from 1^{st} grade elementary through 3^{rd} grade high school requiring correction that have been compartmentalized by age and grade level are recorded and a method for evaluating compositional essays using previously designated terms and keywords.

Also, in one example of the apparatus for grading and evaluating compositional essays of the present invention, the aforementioned second evaluation mechanism possesses a common vocabulary file wherein common vocabulary such as particles, auxiliary verbs, and conjunctions functioning as connective words in a sentence are arranged and stored, a mechanism for making newly arranged unique vocabulary by inserting a break signal such as a half-width space into the place in the composition input by the student where common vocabulary word groups stored in the common vocabulary file have been sequentially deleted, a summary table wherein unique vocabulary extracted from the student's composition is recorded, and a mechanism for summarizing the number of words, expressions, and the like of the unique vocabulary recorded in the summary table and displaying the evaluation of the content of the sentences.

The correlation of fields, terms, keywords, and tasks of the present invention is as follows. In the present invention, for example the similar fields of evaluation for compositional essays from 1^{st} grade elementary through 3^{rd} grade high school are structure, subject matter, expression, topic, and the like. In order to provide guided evaluation in each of these fields a more refined term is used. Terms appropriate for the students of a certain grade level have been designated in advance. Every term corresponds to a keyword and grading and evaluation of the compositional essay is conducted based on the presence or lack of keywords by one example apparatus of the present invention. The supervising teacher will grade terms not corresponding to keywords. Also, independent of these terms, tasks for students of an appropriate grade level have previously been designated. Accordingly, the students will write compositional essays based on both the designated tasks and the designated terms that are independent from the tasks.

The definitions for structure, subject matter, expression, and topic in one example of the short composition grading and evaluation apparatus of the present invention are as follows.

Structure is phrases occurring within a sentence that express relationships between two paragraphs or between a paragraph and the whole. Examples of such phrases are “The reason being”, “The cause being”, “The countermeasure for this being”, and the like.

Subject matter is phrases occurring within a sentence that express actual examples that serve as detailed facts. Examples of such phrases are “In my experience”, “To use an old story as an example”, “According to the data”, and the like.

Expression is phrases occurring within a sentence that express details that are richly expressed through facts or opinions. Examples of such phrases are “It seems as if . . . (for example)”, “The old saying goes”, “according to the famous saying”, and the like.

Topic is phrases occurring within a sentence that express thoughts or opinions concerning ways of looking at, thinking of, or feeling about certain things. Examples of such phrases are “I thought”, “I understood”, “Certainly (to show understanding of a contrary opinion)”, and the like.

The definition for “content” in one different example of the short composition grading and evaluation apparatus of the present invention is as follows. As opposed to the aforementioned example of the short composition grading and evaluation apparatus of the present invention that evaluates sentences from a mainly formal perspective using the fields of structure, subject matter, expression, and topic, the “content” of the other example of the short composition grading and evaluation apparatus of the present invention is an evaluation of the creativity and individuality of a sentence from the perspective of content. The evaluation of content is based on the sentence as a whole, not on designated words.

The first effect of the present invention is providing motivation for the voluntary continuation of study by establishing an objective in sentence writing for the students through clarifing with keywords the formal evaluation terms of compositional essays. For example, in a situation where a student writes a composition by the conventional method, the fields to which self-evaluation of the student's own essay can be applied are limited to the number of letters, length, and the like. As opposed to this, in situations where a composition is written with designated terms and keywords, the student is able to self-evaluate his own composition based on whether or not each term was fulfilled. Having these multiple objectives that can be evaluated is connected to the awareness of these objectives held before writing the composition and the feeling of accomplishment after writing the essay.

The second effect of the present invention is developing serious efforts such as increasing the amount of reading and devising new ways of expression, which are not superficial skills, by motivating the writer, through the evaluation of the composition from the perspective of content that specifies a variety of unique vocabulary, to write better sentences based on the evaluation received. Further, the motivation to increase the variety of vocabulary connects to the desire to add more creativity to real examples and devise more creative ways of expression, which is in accordance with the natural happiness people feel from being creative.

The 3^{rd} effect of the present invention is that evaluation of the composition can be carried out quickly due to the extremely low computational capacity. It is said that there are many sentence evaluation programs that use thousands to ten thousands of lines but the program of the apparatus of the present invention uses a mere 800 lines including the vocabulary dictionary. With this lightweight program it is possible for a student to frequently self-evaluate his own compositional essay using the Internet. Through study with objective goals and the possibility for self-evaluation, the writer can instantly see his own effort reflected in the evaluation providing the writer with a sense of proactive enjoyment like that of sports or games. If multiple people can share the enjoyment of proactive participation then a kind of essay culture can be born. The nurturing of this essay culture by its very nature, considering that it will probably spread like reading culture and intellectual culture, is thought of as having great significance in modern Japanese society.

In the present situation, due to the target being digitalized compositional essays, the present invention is mainly used for evaluation in instances where students are able to input the sentences of the compositional essay into a computer. However, the common vocabulary necessary for the evaluation by the 3rd invention is vocabulary (FIG. 9) limited to 900 words centering mainly on hiragana and simple kanji and therefore it is thought to be able to read hand written characters with a high precision even with the standards of the current optical character-scanning devices. Also, it is not necessary to be aware of the unique vocabulary that remains after the extraction of the common vocabulary and it is thought that there are sufficient gathering capabilities with the current optical character-scanning device as a standard because it is able to gather images that resemble the vocabulary. The result of this is thought to be that using this apparatus and scanner for the grading and evaluation of the writer's compositional essay is the vision for the future.

Further, through one different example of the apparatus for grading and evaluating compositional essays of the present invention, it is thought that due to the characteristics of the method that gathers what remains after the extraction of the common vocabulary that it is possible to easily make an apparatus for grading and evaluating compositional essays appropriate for foreign languages other than Japanese.

### BRIEF DESCRIPTION OF THE DRAWINGS

FIG. 1 is a diagram showing the overall flow.

FIG. 2 is one part of a task table.

FIG. 3 is one part of a term table. (1^{st} grade elementary˜4^{th} grade elementary)

FIG. 4 is one part of a term table. (5^{th} grade elementary˜2^{nd} grade middle)

FIG. 5 is one part of a term table. (3^{rd} grade middle˜3^{rd} grade high)

FIG. 6 is a diagram showing a form used by a student to send a composition or essay.

FIG. 7 is a diagram showing a compositional essay having been evaluated using keywords after having been sent.

FIG. 8 is a diagram showing evaluation results displayed on the Internet.

FIG. 9 is a diagram showing a common vocabulary list (partial).

FIG. 10 is a diagram showing an original sentence made for experimental purposes in order to show the evaluation flow of the 3^{rd} invention.

FIG. 11 is a diagram showing the sentence from FIG. 10 having the common vocabulary omitted.

FIG. 12 is a diagram showing the unique vocabulary that was extracted from the sentence of FIG. 10 and stored in a temporary table in the order of extraction.

FIG. 13 is a diagram showing the unique vocabulary that was extracted from the sentence of FIG. 10 and stored in a temporary table in the order of number of appearances.

FIG. 14 is a diagram showing an image of evaluation results based on the collective unique vocabulary.

FIG. 15 is a diagram showing a chart comparing grading results of an e-rater sample sentence by e-rater, Jess, and this apparatus, the 3^{rd} invention.

FIG. 16 is a diagram showing a graph comparing the grading results of an e-rater sample sentence by e-rater, Jess, and this apparatus, the 3^{rd} invention.

FIG. 17 is a diagram showing a graph comparing the grading of this apparatus with the grading of multiple graders from this school.

FIG. 18 is a chart comparing the grading of this apparatus with the grading of multiple graders from this school.

FIG. 19 is a diagram showing an example English sentence for comparative purposes.

FIG. 20 is a chart with extracted powerful vocabulary (thinking vocabulary).

FIG. 21 is a chart with extracted material vocabulary (common vocabulary), the opposite of unique vocabulary.

FIG. 22 is a chart with extracted sophisticated vocabulary.

FIG. 23 is a chart showing summarized results of 7 English samples from A through G.

FIG. 24 is an analytical graph showing data for each type of word in sample B.

FIG. 25 is a graph made to more easily show the analytical graph of FIG. 24.

FIG. 26 is a diagram showing the evaluation results of the 7 English examples A through G by the apparatus for grading and evaluating compositional essays of the present invention.

FIG. 27 is a diagram showing a polygonal line representing the evaluation of the 7 English samples A through G by the e-rater and two polygonal lines representing the 7 English examples A through G translated into Japanese and evaluated by both Jess and the aforementioned apparatus for grading and evaluating compositional essays of the present invention.

### THE BEST MODE FOR IMPLEMENTING THE INVENTION

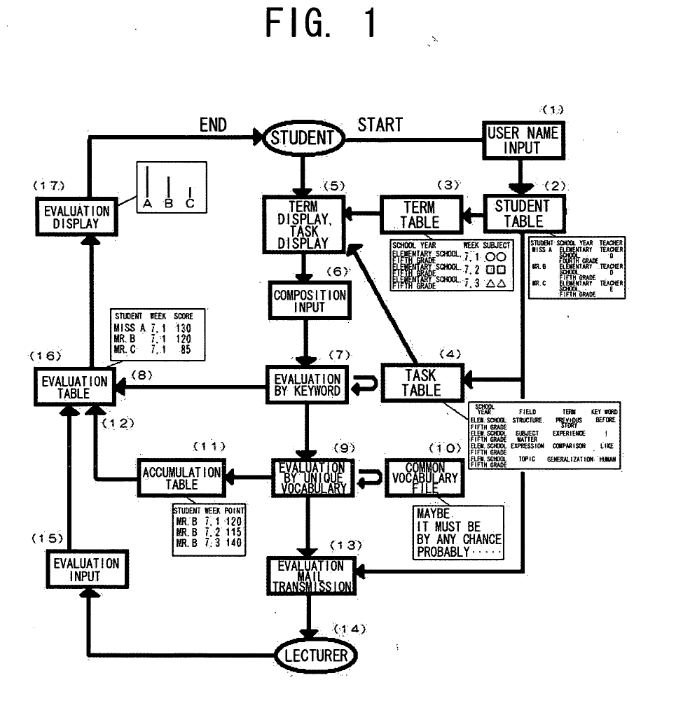

A general outline of the overall flow of this invention follows the following order as shown in FIG. 1.

First, it begins with a student connecting to the Internet.
(1) The student enters his user name. The location for this input is the form displayed in the Internet browser.
(2) The student table acquires the appropriate data concerning the student, grade level, and supervising teacher through the username and calls up current tasks, terms, and the mail address of the supervising teacher.
(3) The task table calls up tasks appropriate for the grade level.
(4) The term table calls up terms and keywords appropriate for the grade level.
(5) The tasks, terms, and keywords that have been called up are displayed in the Internet browser.
(6) The student inputs and sends a compositional essay using the displayed tasks, terms, and keywords.
(7) The compositional essay that was sent is evaluated and graded based on the presence or lack of keywords acquired form the term table.
(8) The results of the grading and evaluation with the keywords are stored in the evaluation table.
(9) Next, the compositional essay that was sent calls up the mechanism for evaluation by unique vocabulary.
(10) The evaluation mechanism acquires the common vocabulary from the common vocabulary file and carries out the grading and evaluation of the extracted unique vocabulary by omitting the common vocabulary from the compositional essay that was sent.
(11) The results of the grading and evaluation by the extracted unique vocabulary are accumulated in the summary table.
(12) The grading and evaluation results constructed in the summary table are stored in the evaluation table.
(13) The results of the grading and evaluation based on the presence or lack of keywords and the results of the grading and evaluation based on the amount of unique vocabulary are added to the compositional essay and sent by e-mail to the supervising teacher.
(14) The teacher checks the grading and evaluation results, adds criticism, and creates the final evaluation data.
(15) The teacher inputs and sends the evaluation data from the Internet.
(16) The evaluation data that was sent is stored in the evaluation table.
(17) The evaluation data stored in the evaluation table is made into a graph or such and shown to the student.

The details of the program that grades and evaluates based on the presence or lack of keywords are as follows.

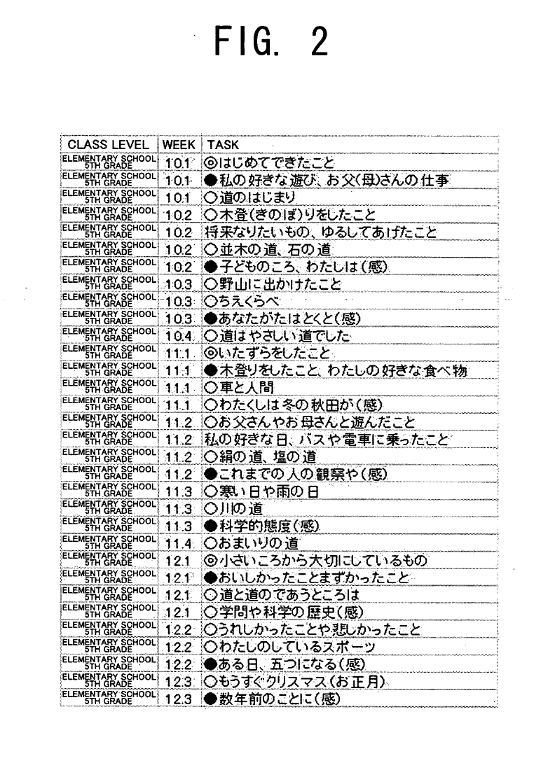

First, the program makes a task table with set tasks appropriate for grade levels from 1^{st} grade elementary through 3^{rd} grade high school. (FIG. 2)

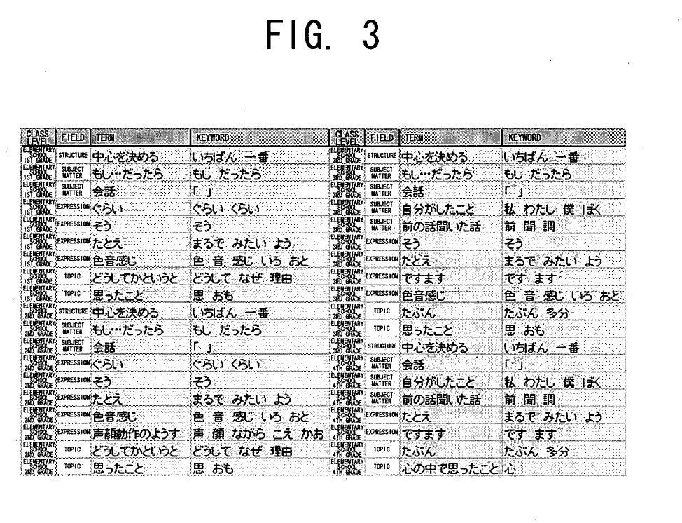

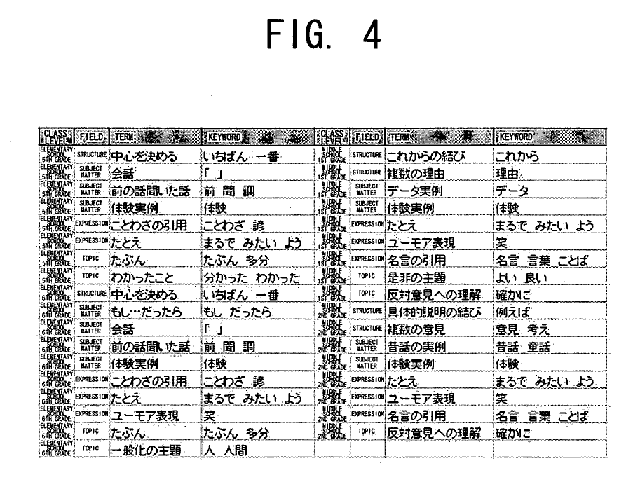

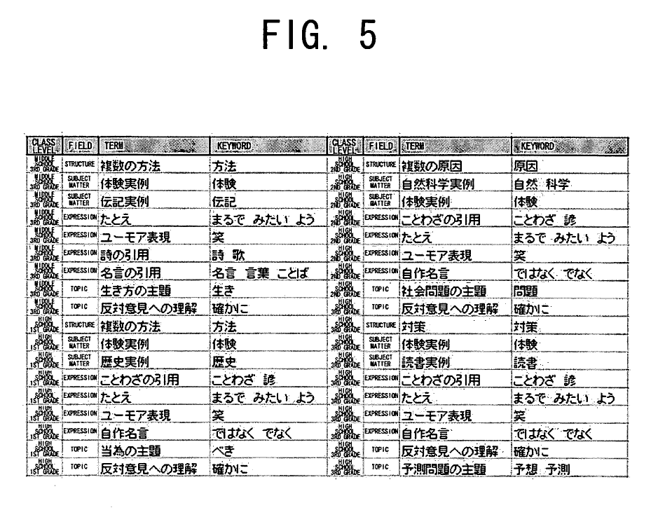

Also, the program makes a term table with set keywords and terms that are the evaluation objectives for compositional essays in fields that all grade levels have in common such as structure, subject matter, expression, topic, and the like. (FIG. 3, FIG. 4, FIG. 5)

Next, the program evaluates whether or not keywords for terms appropriate for the grade level are present in the compositional essay written by the student with tasks appropriate for the grade level.

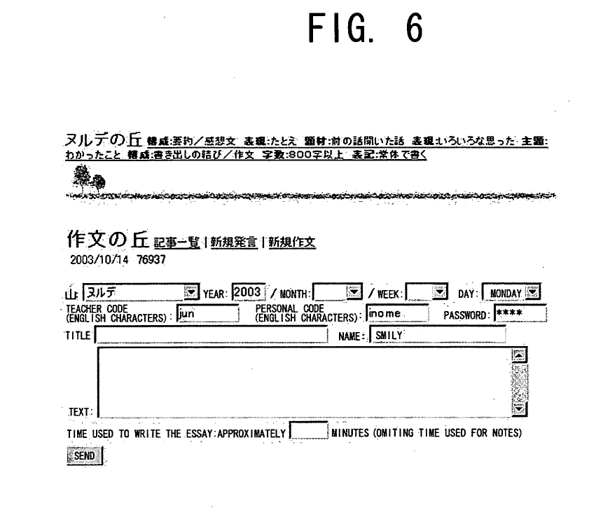

The detailed method for evaluation based on the presence or lack of keywords is as follows. First, using the database each student's grade level information is entered into the student table that is linked to the term table containing terms and keywords appropriate for the grade level. Both of these tables are tied via the Internet to the compositional essay sending form. (FIG. 6) is an image of the sending form.

When a student sends a compositional essay through the Internet, a group of term-specific keywords appropriate for the student's grade level is called up from the term table. The term table evaluates the presence or lack of keywords in the sentences of the composition, displays in color the parts matching the keyword group, and marks those parts with a ⊚ evaluation.

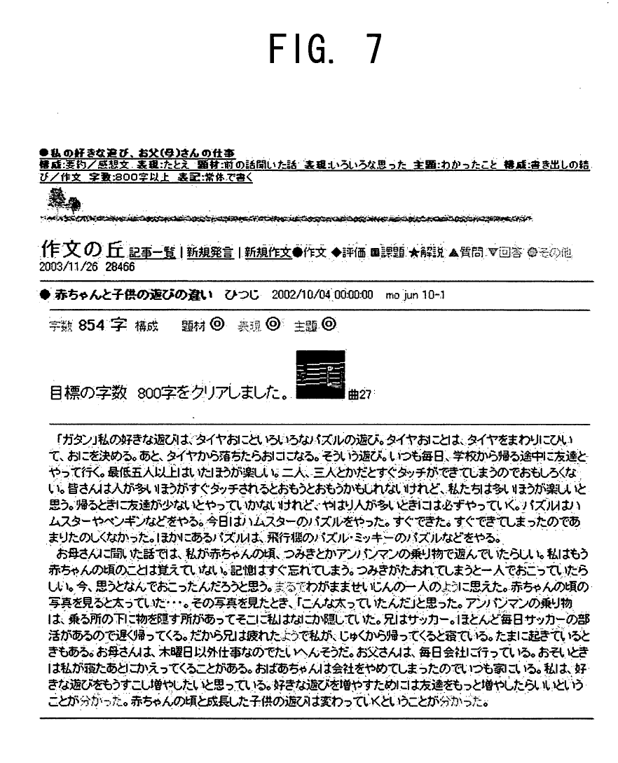

Explained using (FIG. 7), the “hear” of the phrase “the story I heard from my mother . . . ” corresponds to the subject matter terms “previous story, story I heard” and therefore a ⊚ is given for subject matter. Also, the “seem” and “like” from the phrase “he seems like a selfish alien . . . ” correspond to the expression term “for example if” and therefore a ⊚ is given for expression. Also, the “understood” from the phrases “ . . . I understood that it would be good to have more friends.” and “ . . . I understood that children's play is changing.” corresponds to the topic term “understanding” and therefore a ⊚ is given for topic.

There are instances where it is difficult to grade whether or not a term matches a keyword. Evaluation in these instances is withheld and sent by e-mail to the human grader (teacher) via the student table wherein the appropriate teacher for the student is recorded.

The final evaluation, checked and corrected on by the teacher, is accumulated in the evaluation table through the Internet sending form.

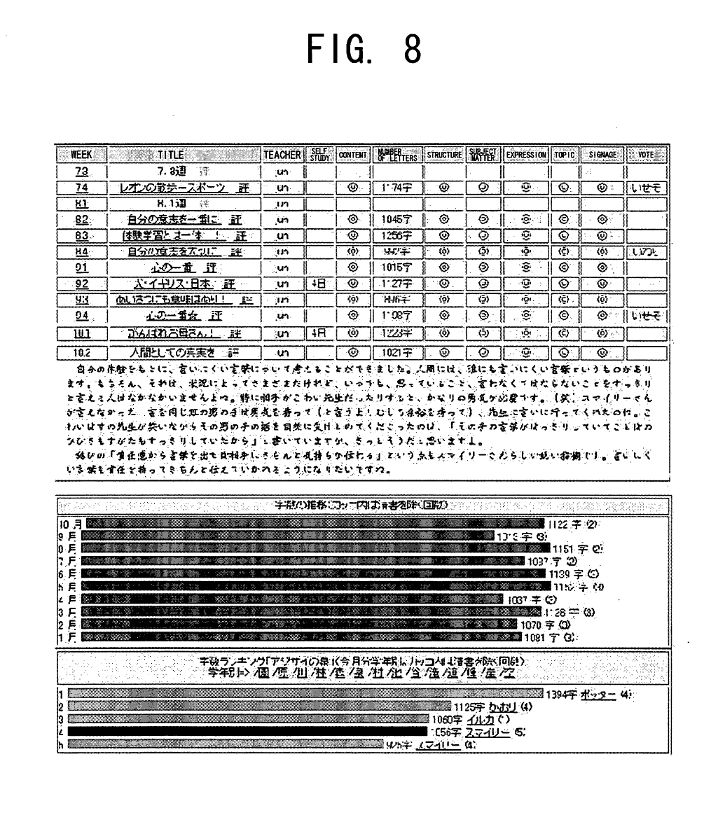

Through the Internet the student can view the evaluation results of his composition and the added corrections by the teacher as well as a graph comparing his results to those students of the same grade level. (FIG. 8) is an image showing the evaluation results of a student.

Whether or not a certain form is achieved and keywords of each term are present or lacking is a way to evaluate one part of composition writing proficiency and is not an overall evaluation, which would include content. For example, it is similar to how in haiku the presence of the 5-7-5 syllable structure and seasonal words that are conditional rules determines whether or not it is a haiku but does not evaluate the content. However, when there is a determined structure, the student is able to understand the evaluation objectives and guidance objectives allowing him to have a feeling of accomplishing a goal beyond merely completing a sentence when he writes a compositional essay. This is a big reason for why the student can work voluntarily for long periods of time on what is usually the tedious task of writing compositional essays.

The details of the embodiment of the evaluation mechanism based on unique vocabulary are as follows.

The evaluation based on the presence or lack of keywords in each term as described above is mainly used to evaluate compositional essays from a structural perspective.

On the other hand, for evaluation from the perspective of content, an evaluation mechanism based on unique vocabulary is used where the sentence is evaluated based on the number and frequency of unique vocabulary that it contains.

Individuality is offered as one of the evaluation points from the perspective of content. Having individuality means that the compositional essay has individuality and contains sentences through which a new way of looking at the world or a new form of expression is introduced. Individuality and creativity are connected to both the appeal of the composition and the writer's enjoyment of writing. The mechanism for evaluation based on unique vocabulary is a way to evaluate the individuality and creativity of sentences through a computer.

In a compositional essay, it can be assumed that within a fixed number of words there is a high correlation between the individuality and creativity from the perspective of content and the use of many varieties of unique vocabulary that are infrequently used. This is the same as the assumption that in everyday conversation a person who has a wealth of conversational topics (subject matter) and vocabulary (expression) is capable of more interesting conversations than a person who is lacking in conversational topics ad vocabulary.

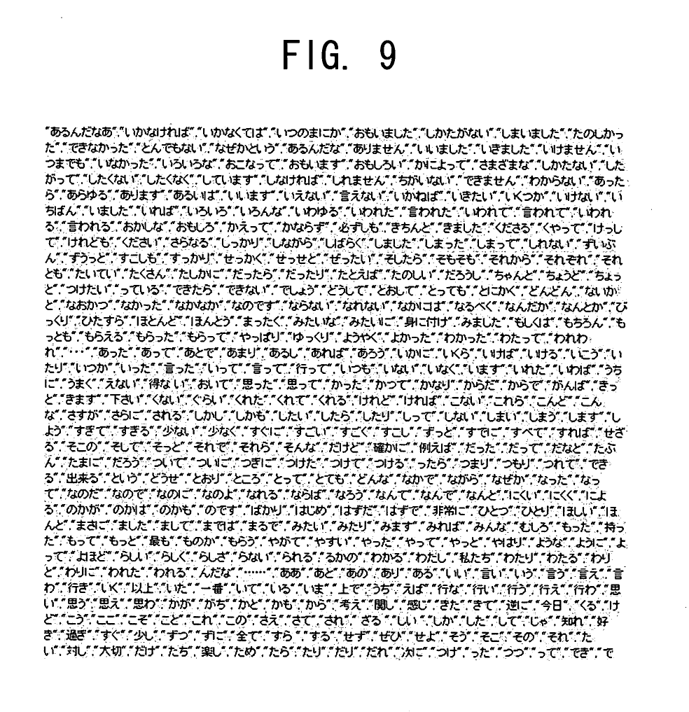

The unique vocabulary is extracted as follows. First, a common vocabulary file is made to collect the common vocabulary. The common vocabulary are particles, auxiliary verbs, adverbs, connective particles, conjunctions, and the like such as “and so, mostly, which is, also, as for” that serve the purpose of connecting phrases within a sentence. This vocabulary can be stored in a small file due to because of its limited size compared to the variety of nouns and verbs. (FIG. 9) is one part of that common vocabulary. In addition, this apparatus uses the morphological analysis software KAKASI (a program that converts kanji into phonetic characters) as the mechanism for leaving spaces between the words of a sentence for the extraction of vocabulary.

Next, the vocabulary (FIG. 10) in the sentence that was sent is checked against the vocabulary groups in the common vocabulary file and the matching words are deleted from the text and a half-width space is inserted as a break signal in the place from which the words were deleted. In these cases, if words with few letters are replaced first then words with many letters cannot be replaced correctly and therefore words with many letters are replaced first. (FIG. 11) is the result after all common vocabulary has been replaced by half-width spaces.

When a sentence that has had all of the common vocabulary replaced by signal breaks such as half-width spaces and arranged and separated by break signals of half-width spaces a list of unique vocabulary (vocabulary other than the common vocabulary) is achieved.

This list of unique vocabulary is stored in the database of the summary table and when gathered by the type of vocabulary the amount of unique vocabulary and number of expressions of unique vocabulary are calculated. However, the types of unique vocabulary tend to gradually decrease as the amount of letters in the sentence increases. For example, the aforementioned calculation is possible when the same vocabulary is only used once in a sentence of 50 letters but is almost impossible when the same vocabulary is only used once in a sentence of 1200 letters. Accordingly, in order to compare short and long sentences equally a regulative ratio appropriate for the number of letters in a sentence is determined.

(FIG. 12) is the unique vocabulary listed in the order it was removed and stored in an interim table called a temporary table.

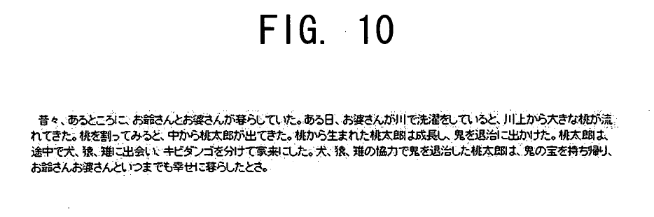

(FIG. 13) is the unique vocabulary gathered by number of appearances and stored in a temporary table.

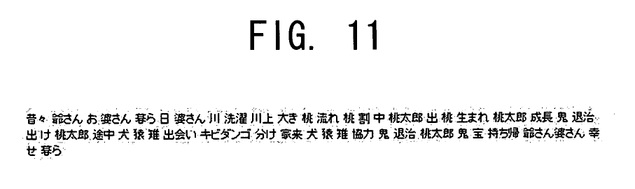

(FIG. 14) is an image showing the evaluation results of the aforementioned sentence compared to the unique vocabulary of other sentences that has been accumulated up until this point in a summary table. In this diagram, in order to evaluate elementary through high school students by the same standards, differences between sentences of opinion and fact and the ratio of kanji used have been added as parameters of the evaluation but the amount of unique vocabulary is still the central point.

A simple overview of the flow of the program that leads from the extraction of unique vocabulary to storage in a summary table is as follows. (the programming language used is PHP)

```
//list of common vocabulary
$ordinary = array(and so, however, because, ...)
//common vocabulary within the sentence is replaced with sequential
half-width spaces.
for($i=0;$I<$count($ordinary);$i++){
    $unique = str_replace(“$ordinary[$i]”,””,$article);
}
//create an arrangement of unique vocabulary separated by half-width
spaces
$unique = explode(“”,$unique);
//extracted unique vocabulary is stored in a sequential database
foreach($unique as $key => $value){
    $query =“insert into table ...... $value .....”;
}
```

One detail of the mechanism for evaluation based on unique vocabulary is that the unique vocabulary is not extracted from the beginning but rather the unique vocabulary is deemed to be whatever is omitted from the common vocabulary. Whatever the language, there will be a huge amount of unique vocabulary and a limited amount of common vocabulary. It is possible for computers with low computational capacity resources to compute quickly due to the method whereby deletion of the limited set pf common vocabulary is used to extract the unique vocabulary.

The evaluation results of the amount of unique vocabulary using the mechanism for evaluating unique vocabulary will now be compared to evaluations conducted by e-rater and Jess. For Jess, the results of an evaluation of a Japanese sentence that is an e-rater evaluation English sample that was translated into Japanese by the creator of Jess are shown. For the present apparatus, an evaluation of a Japanese sentence that is an e-rater sample English sentence that was translated into Japanese by the Excite Company's web translation is used.

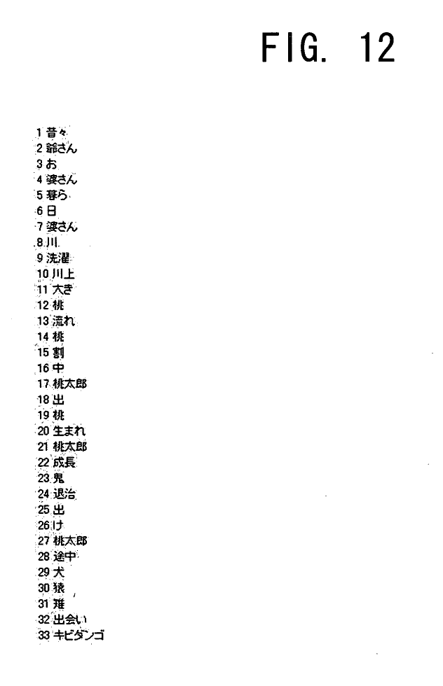

(FIG. 15) is a chart with a comparison of the results of grading by e-rater, Jess, and the present apparatus (by the mechanism that evaluates based on unique vocabulary). A full score for Jess is designated at approximately 10 points but a full score for the present apparatus is designated at approximately 100 points. (FIG. 16) is a graph showing the evaluation values of the present apparatus at one tenth of the scale in order to achieve an easily understandable comparative graph.

As opposed to e-rater and Jess, which evaluate the poorness of a sentence mainly by subtracting points based on various standards, the present apparatus evaluates the individuality of a sentence mainly by adding points by the single standard that is the amount of unique vocabulary. One of the reasons that the graphs for Jess and the present apparatus have almost identical shapes despite the different evaluation methods is that there are large differences between the scores of the multiple sample sentences and taking this into consideration shows that the evaluation of the present apparatus is appropriate when compared to other evaluations.

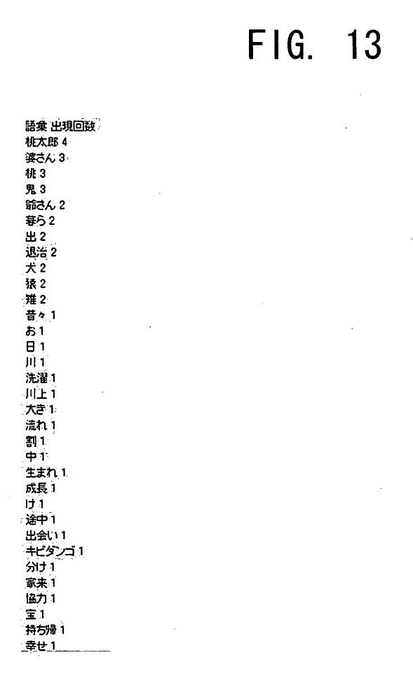

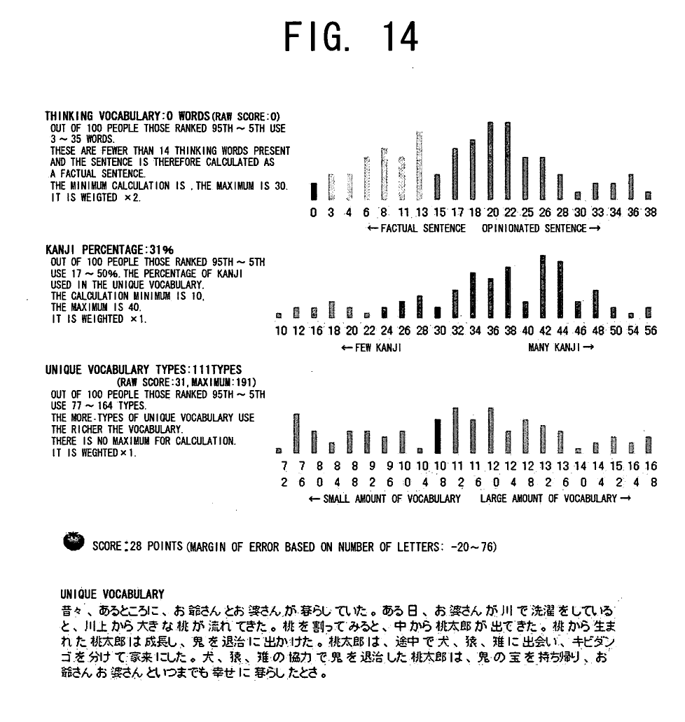

FIG. 17 and FIG. 18 are comparisons of the grading results of compositional essays written by students of this from 4^{th} grade elementary to 3^{rd} grade middle school conducted by this apparatus and multiple graders of this school. The grading system has been converted so that 100 points is a full score. The core evaluation is based on the amount of unique vocabulary but it is necessary to grade and evaluate a range of different grades from elementary to high school using the same standards and therefore the following types of evaluation have been included. One such type is that sentences that have a large amount of vocabulary used in opinion sentences (thinking vocabulary) will be more highly evaluated because sentences focusing on facts are easier to write than sentences focusing on opinions.

Another such type is that sentences that have a large ratio of kanji words (words containing 2 or more kanji) that contain unique vocabulary will be evaluated more highly because sentences with many phonetic characters are easier to write than sentences with many kanji.

However, for compositional essays beyond the middle school level, a maximum limit is placed on the increase of the evaluation in order to ignore the differences from the amount of thinking vocabulary and kanji words. Almost all sentences of students from middle school level exceed this maximum limit and therefore the evaluation is determined almost entirely by the amount of unique vocabulary.

These compositional essay samples and evaluations are publicly displayed on the following site.

Sample (http://www.mori7.net/patent/bm/sample.php)

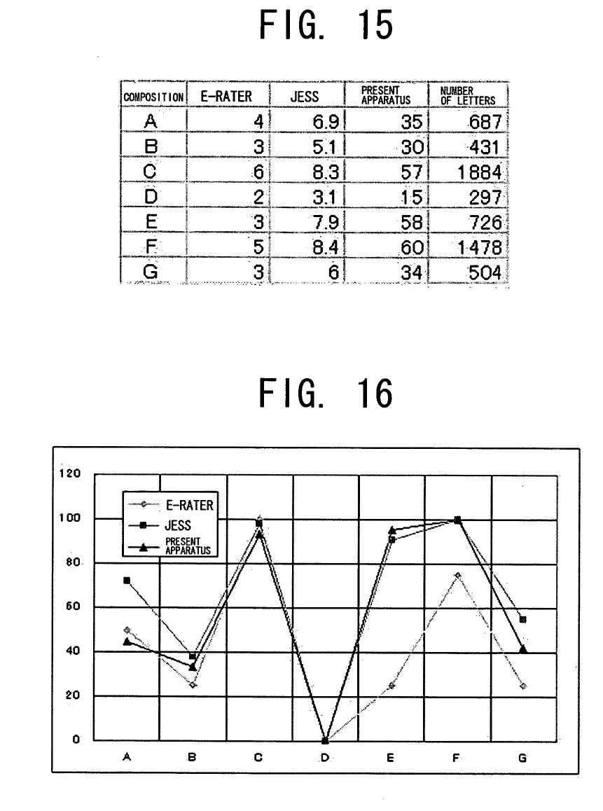

The present invention's possible compatibility with languages other than Japanese will be explained making reference to FIG. 19 through FIG. 27. English has been chosen as an example of a language other than Japanese and while the maximum limit for evaluation in Japanese is 1200 letters, the limit set for evaluation in English is 3600 letters, 3 times that of Japanese. In addition, it should be obvious that these maximum limits were merely chosen for convenience and that the grader is free to choose any number at all.

Next, a thinking vocabulary table and a common vocabulary table are prepared for the evaluation table data. The common vocabulary, which is based on the Japanese common vocabulary including words like “and, there, you” is extracted and the vocabulary that remains is the unique vocabulary. Also, the thinking vocabulary, which is based on the Japanese thinking vocabulary including words like “but, think, therefore”, is extracted. Also, words of two kanji or more in Japanese are tripled in English and become words of 6 or more letters. After preparing this type of English version, it was used to independently evaluate the same samples as the e-rater. The evaluation results are as follows.

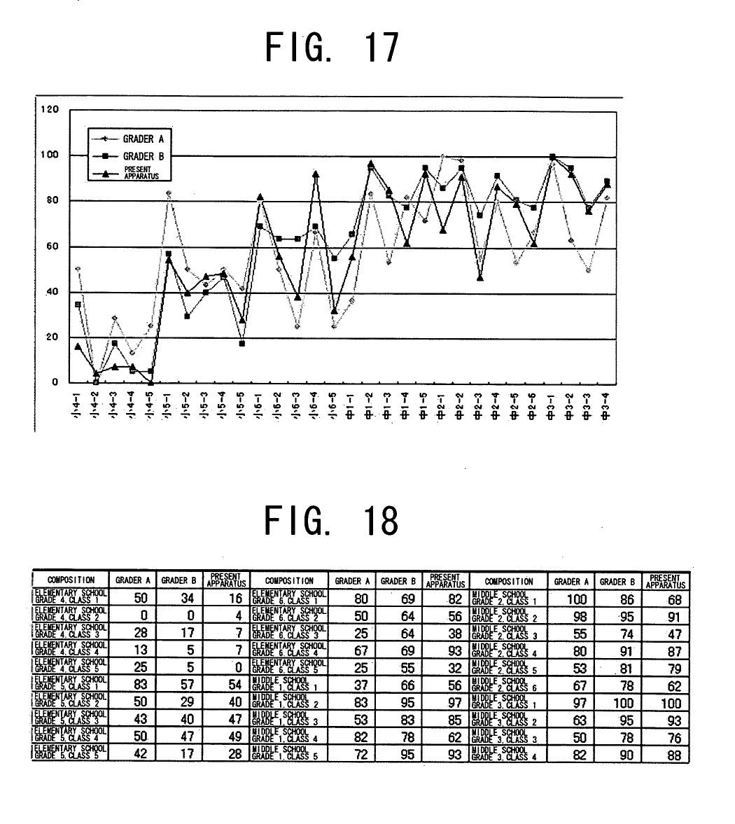

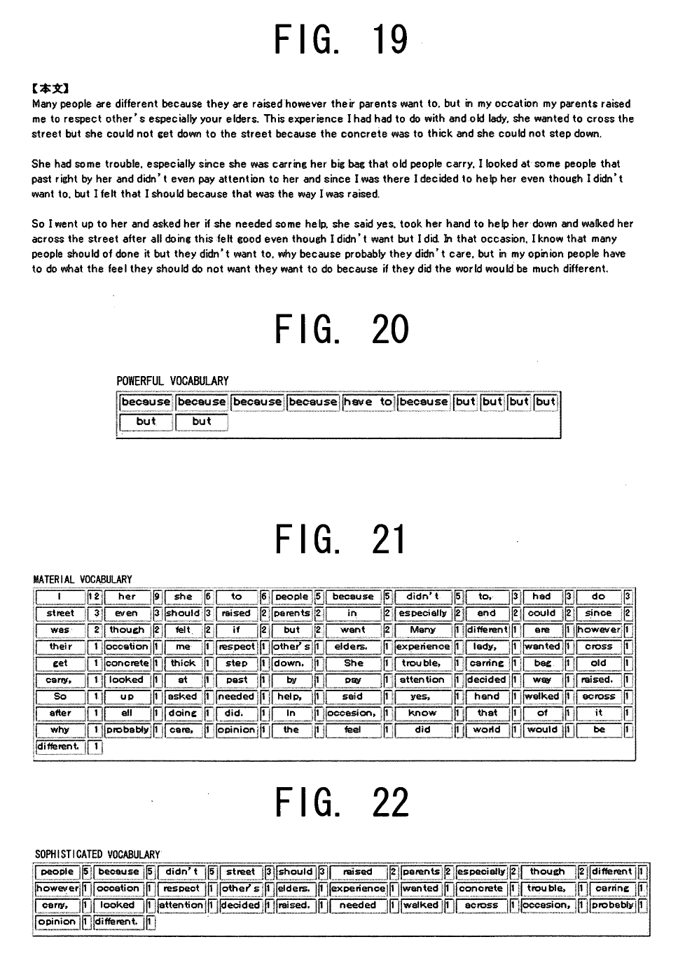

To begin with, FIG. 19 shows one example of a sample sentence for comparison, FIG. 20 is a chart with extracted powerful vocabulary (thinking vocabulary), FIG. 21 is a chart with extracted material vocabulary (common vocabulary) that is the opposite of unique vocabulary, and FIG. 22 is a chart with extracted sophisticated vocabulary. When these extraction operations occur it enables the evaluation operation by processing the data in accordance with the steps shown in FIG. 1.

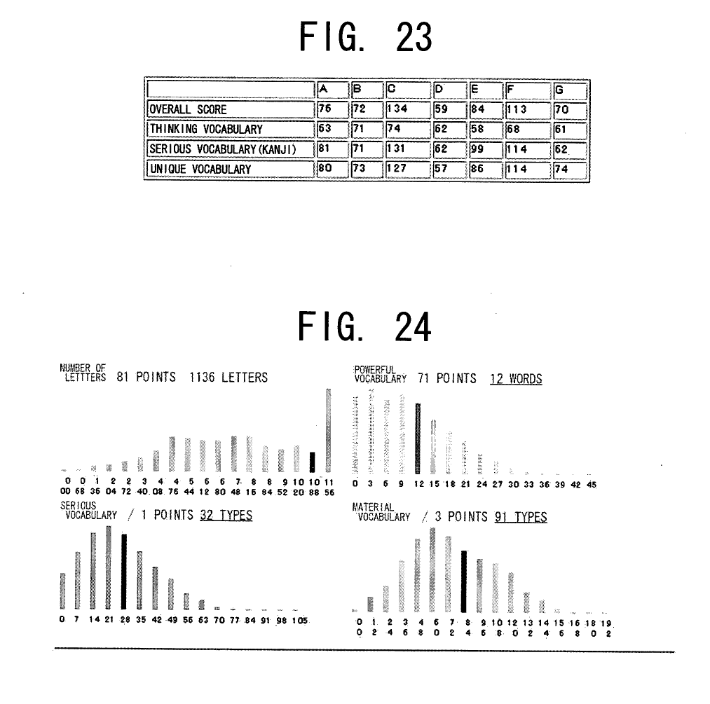

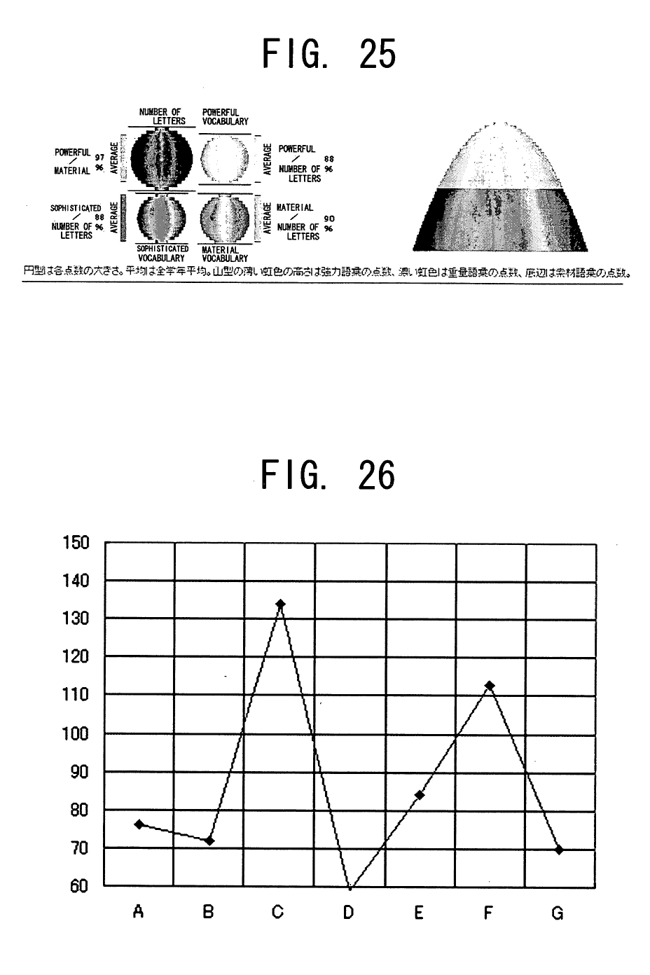

FIG. 23 is a compilation of the evaluations of the 7 English samples A through G. FIG. 24 is an analytical graph showing data about each word in sample B and FIG. 25 is a graph made to display the results of the analytical graph of FIG. 24 in an easily understandable manner. Through FIG. 25, with the required coloring in the original, the good and bad points of the person being evaluated are visually judged and detailed

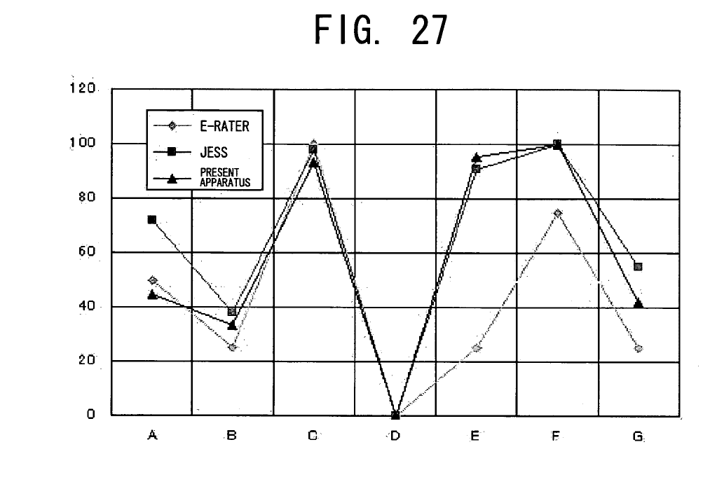

FIG. 26 is a diagram showing the evaluation results of the 7 English examples A through G by the grading and evaluation apparatus of the present invention and, as shown in FIG. 26, it is understood that relatively high scores were obtained as data for sample C and sample F but a relatively low score was obtained as data for sample D. FIG. 27 is a diagram displaying in the same graph a polygonal line representing the evaluations by e-rater of the 7 English samples A through G and 2 polygonal lines representing the evaluations by both the aforementioned apparatus for grading and evaluating compositional essays of the present invention and Jess of the 7 English samples A through G translated into Japanese. As shown in FIG. 26 and FIG. 27, the evaluation results of the 7 English samples A through G by the apparatus for grading and evaluating compositional essays of the present invention, when compared to the polygonal line representing the evaluation of the 7 English samples A through G by e-rater, resemble each other in respect to the relatively low scores obtained as data for sample C and sample F and the relatively high score obtained as data for sample D, thereby showing an extremely high correlation. Also, in the case of the evaluation results of the 7 English samples A through G by the apparatus for grading and evaluating compositional essays of the present invention and Jess, an extremely high correlation is shown for both, which demonstrates the multi-lingual capabilities of the apparatus for grading and evaluating compositional essays of the present invention.

In addition, English and Japanese were shown as examples of various languages for the aforementioned embodiment. However the present invention is not limited to these 2 languages and is capable of evaluation in other languages.

What is claimed is:

1. An apparatus for grading and evaluating compositional essays comprising:
a student table recording a student as a learner of the compositional essay and a corresponding grade level and supervising teacher of the student;
a task table recording a task corresponding to the grade level;
a term table recording a term corresponding to the grade level and a keyword capable of evaluating the achievement of a term based on inclusion of a predetermined keyword in the compositional essay;
an evaluation table recording and storing an evaluation result;
a first evaluation unit evaluating the compositional essay input by the student in accordance with the predetermined task based on the inclusion of the keyword achieving the term;
a second evaluation unit evaluating the compositional essay input by the student based on the amount of unique vocabulary constructing a sentence of the compositional essay;
a unit sending by e-mail the student's compositional essay and evaluation result thereof to the teacher designated by the student table;
a unit reflecting again in the evaluation table the evaluation result sent to and revised by the teacher; and
a unit displaying by forming a graph the evaluation results from the evaluation table.

2. The apparatus for grading and evaluating compositional essays according to claim 1, further comprising a unit evaluating the compositional essay based on a previously designated term and keyword wherein the first evaluation unit includes a term table storing a term and keyword evaluating the four fields of structure, subject matter, expression, and topic, divided as fields to be evaluated in common for compositional essays separated by age and grade level.

3. The apparatus for grading and evaluating compositional essays according to claim 1, wherein the second evaluation unit includes a unit for crating a common vocabulary file storing an arrangement of common vocabulary functioning as a connector in a sentence, such as a particle, an auxiliary verb, and a conjunction, and a new arrangement of unique vocabulary divided by a break signal such as a half-width space inserted into a place from which a common vocabulary group stored in the common vocabulary file was sequentially deleted in a composition input by the student, a summary table recording unique vocabulary extracted from the student's composition, and a unit displaying an evaluation of a sentence's content upon calculation of the number of words and number of appearances of unique vocabulary recorded in the summary table.

4. The apparatus for grading and evaluating compositional essays according to claim 1, changing the number of letters to be evaluated in accordance with a language of the composition to be evaluated.

5. The apparatus for grading and evaluating compositional essays according claim 1, changing a definition of a word considered as sophisticated vocabulary in accordance with a language of the composition to be evaluated.

6. A method for grading and evaluating compositional essays comprising:
setting a student table recording a student as a learner of the compositional essay and a corresponding grade level and supervising teacher of the student, a task table recording a task corresponding to the grade level, a term table recording a term corresponding to the grade level and a keyword capable of evaluating the achievement of a term based on inclusion of a predetermined keyword in the compositional essay, an evaluation table recording and storing an evaluation result;
evaluating a compositional essay input by the student in accordance with the predetermined task based on the inclusion of the keyword achieving a term;
evaluating the compositional essay input by the student based on the amount of unique vocabulary constructing a sentence and;
sending by e-mail the student's compositional essay and evaluation results thereof to the teacher designated by the student table.

7. The method for grading and evaluating compositional essays according to claim 6, further comprising the steps of reflecting again in the evaluation table the evaluation results having been corrected and added by the teacher and displaying through a graph the evaluation results from the evaluation table.
